(19) United States
(12) Patent Application Publication
(10) Pub. No.: US 2023/0174434 A1
(43) Pub. Date: Jun. 8, 2023

(54) METAL-HALIDE COMPOSITE, ARTICLES COMPRISING A METAL-HALIDE COMPOSITE AND METHOD OF MAKING AND USING SAME

(71) Applicant: Government of the United States, as represented by the Secretary of the Air Force, Wright-Patterson AFB, OH (US)

(72) Inventors: Christopher J. Kovacs, Columbus, OH (US); Timothy J. Haugan, Dayton, OH (US)

(21) Appl. No.: 17/988,845

(22) Filed: Nov. 17, 2022

Related U.S. Application Data
(60) Provisional application No. 63/286,175, filed on Dec. 6, 2021.

(51) Int. Cl. C04B 35/82; C04B 35/626; C04B 35/628; C04B 35/657

(52) U.S. Cl. CPC C04B 35/82; C04B 35/6269; C04B 35/62886; C04B 35/657; C04B 35/62881; C04B 2235/444; C04B 2235/522; C04B 2235/5256; C04B 2235/616

(57) ABSTRACT

The present invention relates to a metal-halide composite, articles comprising a metal-halide composite and method of making and using same. The metal-halide matrix materials used in such composite have the desired properties of high thermal conductivity, resistance to thermal induced microstructural changes, and ease of use. As a result, they permit the fabrication of higher performance cryogenic magnets, motors, generators, and cables. Additionally, they permit the fabrication of plate reinforced composites that are useful in lightweight armor and other articles. Additionally, an optoelectronic composite could be built depending on the choice of metal-halide matrix and reinforcement.

### CROSS-REFERENCE TO RELATED APPLICATION

The present application claims priority to U.S. Provisional Application Ser. No. 63/286,175 filed Dec. 6, 2021, the contents of which is hereby incorporated by reference in their entry.

### RIGHTS OF THE GOVERNMENT

The invention described herein may be manufactured and used by or for the Government of the United States for all governmental purposes without the payment of any royalty.

### FIELD OF THE INVENTION

The present invention relates to a metal-halide composite, articles comprising a metal-halide composite and method of making and using same.

### BACKGROUND OF THE INVENTION

Composites are used in a very broad range of structural, electrical, and thermal applications and have replaced many single constituent polymeric, ceramic, glass and metallic options. From a simple rule of mixtures approach, by incorporating two or more constituent materials, composites can be engineered to take advantage of each constituent's desirable properties and partially negate undesirable properties. Incorporating two or more constituent materials can also introduce new physics due to the introduction of interfaces and inhomogeneous materials property structure. Polymer Matrix Composites (PMCs) are a class of easily manufacturable and shapable composites utilized frequently to greatly increase the toughness, stiffness, and decrease the density of a component.

Electrically insulating, continuous ceramic fiber reinforced PMCs are most commonly recognized in their use as structural support boards for electronics. In the case of a high-field superconducting electromagnet with undergoes large internal mechanical loads due to self-Lorentz forces, continuous ceramic fiber reinforced PMCs are used to electrically isolate and mechanically support the winding turns. Superconducting magnets are very temperature sensitive, and steady or transient heat loads can lead to (at best) reduced performance limits or (at worst) permanent damage. It is therefore desirable to rapidly extract heat from the superconducting electromagnetic winding and dump to a cold-sink, but the PMCs that are currently utilized have very low thermal conductivities at cryogenic temperatures. The limiting factor for the PMC thermal conductivity is the polymer matrix.

There remains many other electrically insulating, non-polymeric, higher thermal conductivity materials, however, the material must be mechanically tough, stiff, and be processable to be fully incorporated into a tight winding during the electromagnet manufacturing process. For “react-and-wind” type high-field superconducting magnets (ex: YBCO), processing temperatures cannot exceed 150° C. In the case of “wind-and-react” type high-field superconducting magnets (ex: Nb₃Sn, Nb₃Al, BSCCO) processing temperatures will exceed 600° C. for hours during heat treatment and material limitations keep the maximum temperature below 1000° C. Some high thermal conductivity metal-halide “salts” can be processed by a variety of means in these temperature scenarios. They can be rapidly melt impregnated for higher than 600° C. temperatures, but for lower than 150° C. can still be hot pressed and hot co-extruded or dissolved into a solvent and deposited into materials. When melted, some metal-halides possess very low viscosities, wet materials very well, have minimal vapor pressure, and effectively and rapidly wick deep into tightly packed volumes. With these properties, fiber reinforced metal-halides can be readably fabricated for replacement of PMCs to permit higher performing high-field superconducting magnets. As cryogenics expands further into motors and generators, metal-halide matrix composites can be used to reinforce the superconducting or resistive windings in these applications.

The maximum use temperature of PMCs is typically limited by the polymer matrix and falls below 350° C. due to volatility and softening of the matrix. For higher temperature applications which rely on electrical isolation and complex geometry components, the switch usually falls to glass matrix composites manufactured via controlled crystallization of a glass matrix, such as Macor, Pyroceram, Keralite, or others. During manufacture, the molten glass can have high viscosity, making it difficult to impregnate into tight gaps. Additionally, subsequent heat treatments to crystallize phases can create substantial thermal loads on any other integrated components. Some metal-halides are able to rapidly impregnate into molecular sized spaces, reducing thermal loading and resulting in net shape composites with large reinforcement fractions which do not require additional processing.

Applicants recognized that the source of the problem that impeded a matrix material's ability to have the desired properties of high thermal conductivity at cryogenic temperatures, thermal microstructural stability at elevated temperatures and ease of use was that current polymers have are not sufficiently crystalline and have too many configurational degrees of freedom, are too prone to dissociation and reaction in atmospheric conditions, and are too viscous when liquid or prepared in multicomponent mixtures. Thus, Applicants turned to metal-halides. Applicants metal-halides have excellent adherence when bonding to 2-D van der Waals materials (ex: graphite, MoS₂) which permits the fabrication of unique plate reinforced composites that are useful in lightweight armor. Additionally, an optoelectronic composite could be built depending on the choice of metal-halide matrix and reinforcement.

### SUMMARY OF THE INVENTION

The present invention relates to a metal-halide composite, articles comprising a metal-halide composite and method of making and using same. The metal-halide materials used in such composites have the desired properties of high thermal conductivity, heat degradation resistance and ease of use. As a result, they permit the fabrication of unique plate reinforced composites that are useful in lightweight armor and other articles. Additionally, an optoelectronic composite could be built depending on the choice of metal-halide matrix and reinforcement.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a continuous fiber reinforced metal-halide composite having (1) a reinforcement phase and (2) metal-halide.

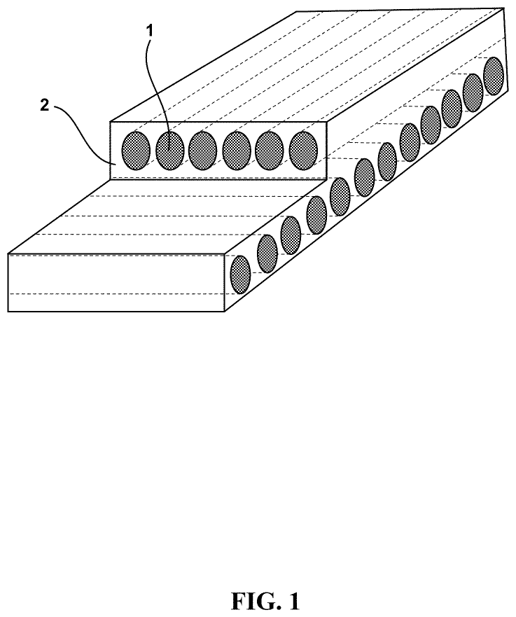

FIG. 2 depicts a particulate reinforced metal-halide composite having (1) a reinforcement phase and (2) metal-halide.

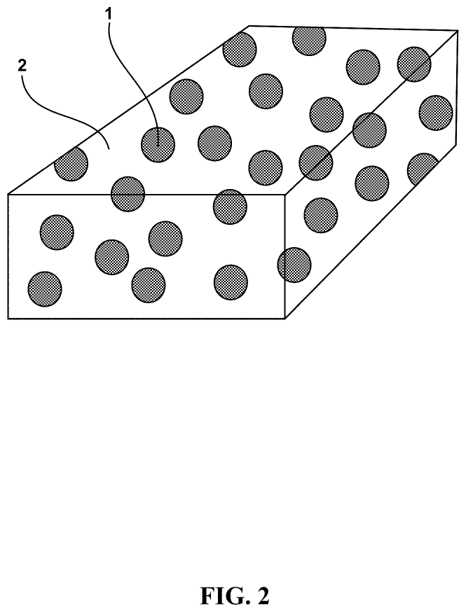

FIG. 3 depicts a randomly oriented chopped fiber reinforced metal-halide composite having (1) a reinforcement phase and (2) metal-halide.

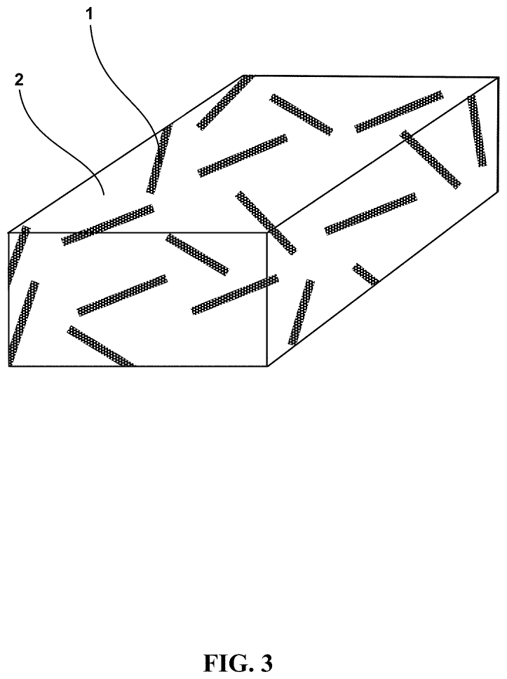

FIG. 4 depicts a continuous fiber fabric reinforced metal-halide composite having (1) a reinforcement phase and (2) metal-halide.

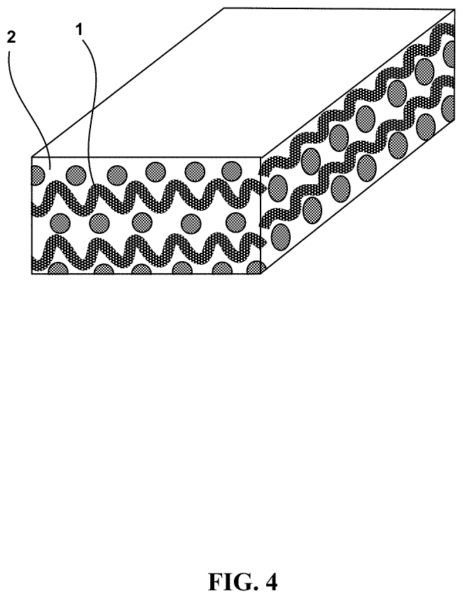

FIG. 5 depicts a plate reinforced metal-halide composite having (1) a reinforcement phase and (2) metal-halide.

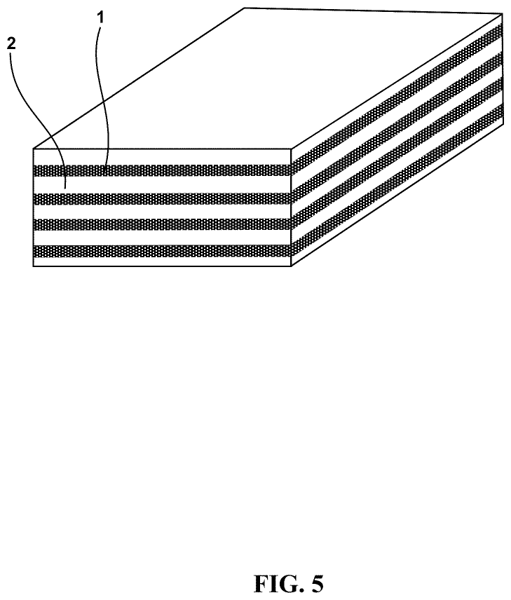

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### DETAILED DESCRIPTION OF THE INVENTION

### Metal-Halide Composite and Articles Comprising Same

For purposes of this specification, headings are not considered paragraphs and thus this paragraph is paragraph twenty-four of the present specification. The individual number of each paragraph above and below this paragraph can be determined by reference to this paragraph's number. In this paragraph twenty-four, Applicant discloses a metal-halide composite comprising:
a) a metal-halide matrix, said metal-halide matrix comprising a metal-halide that comprises a metal selected from the group consisting of an alkali metal, an alkaline earth metal, a transition metal, a basic metal, a semimetal and mixtures thereof, preferably said metal-halide matrix comprises a metal-halide that comprises a metal selected from the group consisting of an alkali metal, a basic metal and mixtures thereof and a halide selected from the group consisting of F, Br, I, Cl and mixtures thereof, more preferably said metal-halide matrix comprising a metal-halide that comprises a metal selected from the group consisting of cesium, thallium mixtures thereof and a halide selected from the group consisting of F, Br, I, Cl and mixtures thereof, most preferably said metal-halide matrix comprises a metal-halide selected from the group consisting of cesium iodide, thallium iodide and mixtures thereof; and
b) a reinforcement material, said reinforcement material being dispersed within said metal-halide matrix said metal-halide composite having a metal-halide matrix to reinforcement material ratio, based on total metal halide composite weight of about 1:99 to about 99:1. For mechanical support in cryogenic (superconducting or resistive) magnets, motors, and generators, the metal-halide matrix to reinforcement ratio can be 99:1 to take advantage of high thermal conductivity matrix to 15:85 in the case of high strength continuous fiber or woven fiber reinforcement. For adherence and lamination of plates for electromagnetic or mechanical shielding or support, the metal-halide matrix to reinforcement ratio can be 50:50 to 1:99. For electrical isolating boards and stand-offs the metal-halide matrix to reinforcement ratio can be 90/10 to 10/90. For optoelectronic devices, the metal-halide to reinforcement ratio can be 99:1 to 1:99.

Applicant discloses the metal-halide composite according to paragraph twenty-four wherein said reinforcement material is selected from the group consisting of polymeric, metallic, glass or ceramic chopped fibers, particulates, continuous fibers, woven fibers, and mixtures thereof, preferably said reinforcement material is selected from the group consisting of glass or ceramics chopped fibers, particulates, continuous fibers, woven fibers, and mixtures thereof, more preferably said reinforcement material is selected from the group consisting of glass chopped fibers, continuous fibers, or woven fibers and mixtures thereof, most preferably said reinforcement material comprises glass woven fibers.

Applicant discloses the metal-halide composite according to paragraph twenty-four wherein:
a) said metal-halide matrix comprises cesium iodide and said reinforcement material comprises S-glass woven fabric;
b) said metal-halide matrix comprises cesium bromide and said reinforcement material comprises S-glass woven fabric;
c) said metal-halide matrix comprises thallium iodide and said reinforcement material comprises S-glass woven fabric;
d) said metal-halide matrix comprises thallium bromide and said reinforcement material comprises S-glass woven fabric;
e) said metal-halide matrix comprises cesium iodide and said reinforcement material comprises composite superconducting wires and/or tapes;
said metal-halide matrix comprises cesium bromide and said reinforcement material comprises composite superconducting wires and/or tapes;
g) said metal-halide matrix comprises thallium iodide and said reinforcement material comprises composite superconducting wires and/or tapes;
h) said metal-halide matrix comprises thallium bromide and said reinforcement material comprises composite superconducting wires and/or tapes;
i) said metal-halide matrix comprises cesium iodide and said reinforcement material comprises copper wire;
j) said metal-halide matrix comprises cesium bromide and said reinforcement material comprises copper wire;
k) said metal-halide matrix comprises of thallium iodide and said reinforcement material comprises copper wire; or
l) said metal-halide matrix comprises thallium bromide and said reinforcement material comprises copper wire.

Applicant discloses the metal-halide composite according to paragraphs twenty-four through twenty-six, said metal-halide composite having a thermal conductivity of at least 1 watt/meter K, from about 1 watt/meter K to about 500 watts/meter K, or from about 3 watts/meter K to about 500 watts/meter K.

Applicant discloses the metal-halide composite according to paragraphs twenty-four through twenty-seven, said metal-halide composite having a thermal induced microstructural change of from about 0 to about 100 percent of the volume, preferably said metal-halide composite has a thermal induced microstructural change of from about 0 to about 50 percent of the volume, more preferably said metal-halide composite has a thermal induced microstructural change of from about 0 to about 5 of the volume, most preferably said metal-halide composite has a thermal induced microstructural change of from about 0.001 to about 0.1 percent of the volume.

Applicant discloses an article comprising a metal-halide matrix according to paragraphs twenty-four through twenty-eight.

Applicant discloses an article according to paragraph twenty-nine, said article being a magnet, generator a motor, wire or cable, in one aspect, said magnet is a superconducting magnet, a pulse magnet, a resistive magnet or high temperature magnet, said motor is a cryogenic motor or high temperature motor, said generator is cryogenic generator or high temperature generator, said cable is a signal and/or power cable and said wire is a signal and/or power wire.

Applicant discloses an aerospace vehicle comprising a metal-halide composite according to paragraphs twenty-four through twenty-eight or the article of paragraphs twenty-nine through thirty.

Suitable materials for making the metal-halide composites of paragraphs twenty-three through thirty can be obtained from Sigma Aldrich Inc. of Saint Louis, Mo., American Elements of Los Angeles, Calif., ACP Composites Inc. of Livermore, Calif., Specialty Materials Inc. of Lowell, Mass. and Dexmat Inc. of Houston, Tex.

### Process of Making Metal-Halide Composite

Applicant discloses a process of making a metal-halide composite comprising combining a metal-halide and a reinforcement material and allowing said metal-halide composite to cure or curing said metal-halide composite.

Applicant discloses a process according to paragraph thirty-three wherein said combining comprises:
a) mechanical blending of the metal-halide and reinforcement in the solid state and consolidation followed by pressing and/or extrusion (elevated temperatures and a controlled atmosphere may be utilized to assist in bonding and densification);
b) mechanical blending of the reinforcement into a liquid state metal-halide followed by solidification of the metal-halide (note that in this case, mechanical blending is synonymous with stir casting);
c) melt infiltration of a liquid state metal-halide into a reinforcement preform;
d) vacuum melt impregnation of a liquid state metal-halide into a reinforcement preform;
e) squeeze casting of a liquid state metal-halide into a reinforcement preform;
d) infiltrating a solvent metal-halide solution into a reinforcement preform followed by solvent extraction to form a metal-halide composite and optionally densification of said metal-halide composite by pressing and/or extrusion;
e) coating a solvent metal-halide solution on a reinforcement powder to form a metal-halide matrix composite, and optionally consolidating said metal-halide composite by pressing and/or extrusion (elevated temperatures and a controlled atmosphere may be utilized to assist in bonding and densification);
f) reacting a metal and a halide reactant in the presence of a reinforcement material to form a metal-halide matrix composite and optionally consolidating said metal-halide matrix composite by pressing and/or extrusion (elevated temperatures and a controlled atmosphere may be utilized to assist in bonding and densification); or
g) depositing a metal-halide coated reinforcement material on a substrate material and/or assembly to form a metal-halide coated reinforcement, in one aspect, said deposition comprises cold-spraying said metal-halide coated reinforcement on a substrate material and/or assembly, hot-spray said metal-halide coated reinforcement on a substrate material and/or assembly, painting said metal-halide coated reinforcement on a substrate material and/or assembly and/or printing said metal-halide coated reinforcement on a substrate material and/or assembly.

### Test Methods

Method for determining thermal conductivity of the metal-halide composite using the transient triple omega technique. For the purpose of this specification, the following method shall be used:
1) Precision machine (within 0.005″) one bar of the composite with dimensions 0.2″×0.2″×0.5″. Make sure the object is as close to a perfect rectangular prism as possible, with neighboring sides 90-degrees perpendicular.
2) Precision machine (within 0.005″) one bar of the composite with dimensions 0.2″×0.2″×1″. Make sure the object is as close to a perfect rectangular prism as possible, with neighboring sides 90-degrees perpendicular.
3) Gently grind all sides of both bars down using 180, 320, 600, and finish with 800 grit SiC paper. The maximum surface roughness should fall below 10 micrometers.
4) Sandwich a 10 micrometer Invar wire between both bars and mechanically press the two bars to ensure the wire and two bars are all in intimate contact and simulate an embedded wire. Invar wire will be the transient heating element.
4) Injecting a sinusoidal current (1-ω) into the Invar wire will generate Joule heating in the wire with a frequency of 2 times the frequency of the sinusoidal current (2-ω).
5) The resistance of the wire will change due to the thermal dependence of resistivity with a frequency of 2 times the frequency of the input sinusoidal current. The amount of temperature change is associated with the thermal properties of the bars.
6) Ohms law is used to calculate the voltage. The temperature dependent resistance frequency of 2 times the input current frequency, multiplied by the input current frequency, results in a voltage signal with a 1-ω component and a component with a frequency 3 times the input frequency (3-ω). This 3-ω voltage signal is utilized to determine the thermal conductivity of the bars.
7) The 1-ω voltage component is frequently orders of magnitude larger than the 3-ω voltage, and therefore a three-wire Wheatstone bridge, constructed of high precision resistors, is used to attenuate the large 1-ω component and remove the contribution of the two current leads which connect to the Invar wire.
8) A lock-in amplifier (Signal Recovery 7270) drives the Wheatstone bridge and measures the 3-ω voltage.
9) Thermal conductivity is accurately measured using the following equation:

$$k = \frac{( {V}_{0}^{3} β )}{16 {πR}_{h} l * ζ}$$

where V₀ is the applied driving voltage to the Invar wire, β is the temperature coefficient of resistance of the Invar wire, Rₕ is the resistance of the heater, l is the length of the Invar wire, and ζ is the following slope:

$$ζ = \frac{d ( {V}_{3 ω , in} )}{d ( ln ( 2 ω ) )}$$

Where V_{3-ω,in} is the in-phase 3-ω voltage, and ω is the frequency of the input current.
10) Determining the slope requires multiple frequency measurements; the frequency of each measurement must fall in the range of:

$$\frac{12.5 α}{{{t}_{s}}^{2}} < ω < \frac{α}{50 {{b}_{h}}^{2}}$$

where α is the thermal diffusivity of the bar samples, tₛ is the thickness of the sample, and bₕ is the radius of the Invar wire. This ensures a semi-infinite solid approximation for the sample, i.e. other neighboring materials are not investigated.
11) The sample is measured in a temperature controlled cryostat, cooled with direct contact with cold flowing helium vapor. The temperature is monitored using a calibrated silicon diode thermometer. The temperature of the flowing helium vapor and sample holder is controlled using a Lakeshore Model 335 temperature controller.

Method for determining thermal induced microstructural changes. For the purpose of this specification, the following method shall be used:
1) Mount a 5 mm×5 mm×5 mm piece of the composite and grind to 1200 grit with ethanol lubricant. Then dry polish using alumina or diamond powder without lubricant and rinse with ethanol.
2) Examine the microstructure with a FEI Quanta 200 SEM-EDS at 15 kV accelerating voltage before thermal exposure. Record the composition and size of different regions and the thicknesses of compositional gradients (if any) created during metal-halide matrix composite manufacture.
3) Expose a separate piece of the metal-halide matrix composite to the desired thermal environment for a desired time. This environment and time should be representative of the exposure when the material is fielded.
4) Examine the microstructure with a FEI Quanta 200 SEM-EDS at 15 kV accelerating voltage after thermal exposure. Record the composition and size of the different regions and the thicknesses of compositional gradients (if any). Record any differences with the as-made composite. Any differences with the as-made composite may correlate to differences in mechanical, electrical and thermal properties.

Method for determining flexural strength using the four point bending method. For the purpose of this specification, ASTM C1341-13 shall be used.

### EXAMPLES

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

Example 1: A mixture of methylcellulose, deionized water, and CsI was used to create a gel. At first, CsI was mixed with water with a CsI:H2O weight ratio of 3:4. Because this process is somewhat endothermic, the CsI:H₂O mixing occurred at 70° C. on a hot-plate with a stirrer until the CsI was clearly dissolved. Methylcellulose was then added to the mixture for a final methylcellulose:CsI:H₂O weight ratio of 1:30:40. Other ratios with higher methylcellulose content can be created to increase or decrease the viscosity. The gel was then impregnated into a S-glass sheathed OFHC Cu bar and dried at room temperature. It is clear that the saline gel is slightly corrosive because it brightened the Cu bar.

Alumina crucibles were used to house CsI (99.9% purity), OFHC Cu foil, 304 S.S. strips, TiAl4V6 bar, and tightly packed (more than 15 layers) S-glass insulation. The crucibles were placed in a three-zone horizontal tube furnace in a stainless steel retort for high-purity flowing argon atmospheric control. The retort seals were first vacuum tested. The melt impregnation heat treatment is as follows: ramp to 150° C.@2° C./min (under vacuum), then 10 min@150° C. (under vacuum) for removing any moisture in the CsI powder, then ramp to 640° C. at 2° C./min (under flowing high purity Ar@100 sccm), then 10 min@640° C. (under flowing high purity Ar@100 sccm), then furnace cool (under flowing high purity Ar@100 sccm). Furnace cooling took approximately 4 hrs. The resulting impregnation adhered excellently to all materials, did not clearly react with any of the materials, and wicked up the S-glass insulation.

4 alumina crucibles were separately sprayed with dry film graphite lubricant (Sprayon Products LU 204), boron nitride (Saint Gobain DC-18), zirconium dioxide (ZYP coatings), and dry molybdenum disulfide (CRC industries). A 304 S.S. washer was coated in each crucible and also sprayed with the respective coating. The crucibles were heat treated under 150 sccm high purity argon as follows: 680° C.@5° C./min then 680° C. for 10 s then furnace cool. Furnace cooling to 150° C. took about 4 hrs. The CsI adhered excellently to the lubricated alumina crucibles and lubricated 304 S.S. washer in the case of graphite, zirconium dioxide, and molybdenum disulfide. Molten CsI reacted with boron nitride power to form a grayish powder.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A metal-halide composite comprising:
a) a metal-halide matrix, said metal-halide matrix comprising a metal-halide that comprises a metal selected from the group consisting of an alkali metal, an alkaline earth metal, a transition metal, a basic metal, a semimetal and mixtures thereof; and
b) a reinforcement material, said reinforcement material being dispersed within said metal-halide matrix said metal-halide composite having a metal-halide matrix to reinforcement material ratio, based on total metal halide composite weight of about 1:99 to about 99:1.

2. The metal-halide composite according to claim 1 wherein said reinforcement material is selected from the group consisting of polymeric, metallic, glass or ceramic chopped fibers, particulates, continuous fibers, woven fibers, and mixtures thereof.

3. The metal-halide composite according to claim 1 wherein:
a) said metal-halide matrix comprises cesium iodide and said reinforcement material comprises S-glass woven fabric;
b) said metal-halide matrix comprises cesium bromide and said reinforcement material comprises S-glass woven fabric;
c) said metal-halide matrix comprises thallium iodide and said reinforcement material comprises S-glass woven fabric;
d) said metal-halide matrix comprises thallium bromide and said reinforcement material comprises S-glass woven fabric;
e) said metal-halide matrix comprises cesium iodide and said reinforcement material comprises composite superconducting wires and/or tapes;
f) said metal-halide matrix comprises cesium bromide and said reinforcement material comprises composite superconducting wires and/or tapes;
g) said metal-halide matrix comprises thallium iodide and said reinforcement material comprises composite superconducting wires and/or tapes;
h) said metal-halide matrix comprises thallium bromide and said reinforcement material comprises composite superconducting wires and/or tapes;
i) said metal-halide matrix comprises cesium iodide and said reinforcement material comprises copper wire;
j) said metal-halide matrix comprises cesium bromide and said reinforcement material comprises copper wire;
k) said metal-halide matrix comprises of thallium iodide and said reinforcement material comprises copper wire; or
l) said metal-halide matrix comprises thallium bromide and said reinforcement material comprises copper wire.

4. The metal-halide composite according to claim 1, said metal-halide composite having a thermal conductivity of at least 1 watt/meter K, from about 1 watt/meter K to about 500 watts/meter K, or from about 3 watts/meter K to about 500 watts/meter K.

5. The metal-halide composite according to claim 1, said metal-halide composite having a thermal induced microstructural change of from about 0 to about 100 percent of the volume.

6. An article comprising a metal-halide composite according to claim 1.

7. The article of claim 6, said article being a magnet, generator a motor, wire or cable.

8. An aerospace vehicle comprising a metal-halide composite according to claim 1.

9. A process of making a metal-halide composite comprising combining a metal-halide and a reinforcement material and allowing said metal-halide composite to cure or curing said metal-halide composite.

10. The process of claim 9 wherein said combining comprises:
a) mechanical blending of the metal-halide and reinforcement in the solid state and consolidation followed by pressing and/or extrusion;
b) mechanical blending of the reinforcement into a liquid state metal-halide followed by solidification of the metal-halide;
c) melt infiltration of a liquid state metal-halide into a reinforcement preform;
d) vacuum melt impregnation of a liquid state metal-halide into a reinforcement preform;
e) squeeze casting of a liquid state metal-halide into a reinforcement preform;
d) infiltrating a solvent metal-halide solution into a reinforcement preform followed by solvent extraction to form a metal-halide composite and optionally densification of said metal-halide composite by pressing and/or extrusion;
e) coating a solvent metal-halide solution on a reinforcement powder to form a metal-halide matrix composite, and optionally consolidating said metal-halide composite by pressing and/or extrusion;
f) reacting a metal and a halide reactant in the presence of a reinforcement material to form a metal-halide matrix composite and optionally consolidating said metal-halide matrix composite by pressing and/or extrusion;
g) depositing a metal-halide coated reinforcement material on a substrate material and/or assembly to form a metal-halide coated reinforcement.
